(19) United States
(12) Patent Application Publication
(10) Pub. No.: US 2023/0128884 A1
(43) Pub. Date: Apr. 27, 2023

(54) METHOD AND DEVICE FOR MAKING ICED BEVERAGES

(71) Applicants: STEVEN M. FASSBERG, BOCA RATON, FL (US); PETER P. DUNNE, BETHLEHEM, PA (US); BRANDON R. FASSBERG, ASTORIA, NY (US)

(72) Inventors: STEVEN M. FASSBERG, BOCA RATON, FL (US); PETER P. DUNNE, BETHLEHEM, PA (US); BRANDON R. FASSBERG, ASTORIA, NY (US)

(21) Appl. No.: 17/954,110

(22) Filed: Sep. 27, 2022

Related U.S. Application Data
(60) Provisional application No. 63/272,048, filed on Oct. 26, 2021.

(51) Int. Cl. A47J 31/00

(52) U.S. Cl. CPC A47J 31/005

(57) ABSTRACT

A device and method are provided for making iced beverages. The iced beverage device and method can be made either as a commercial multi serve unit for restaurants, coffee shops, and convenience stores, or as a single serve for home use. The device creates a frozen inner shell of the constituent beverage that lines the inner perimeter of a serving cup of any beverage product, iced cream, smoothie, alcoholic beverage or mixer, dairy product, coffee, soft drink, juice, or any product which is required to be kept cold, by totally eliminating dilution and the need for ice.

### FIELD OF THE INVENTION

This invention relates to beverage devices, and more particularly to device and method of making cooled or iced beverages without the dilution incurred with the use of water-based ice cubes.

### BACKGROUND OF THE INVENTION

Cold or chilled beverages are always popular with consumers. Traditionally water based iced cubes are added to a beverage to cool the beverage. However, ice cubes by their very nature dilute the beverage as the ice cubes melt into water thereby changing the taste of the beverage. For the consumer there is a perceived loss of value with being served a beverage that is full of ice instead of the product they want. For the foodservice industry, the use of ice cubes makes portion control difficult and introduces a level of unpredictability to the cost of goods sold, as “user error” in arbitrarily filling a beverage container with ice cubes impacts the amount of actual product in a customer's serving.

While there has been a continuous demand for cooled beverages, there still exists a need for an improved method and beverage serving device for providing cooled and iced beverages to consumers in both their home and in food service locations.

### SUMMARY OF THE INVENTION

A single serve device is provided for making iced beverages. The device includes a cup with a first circumference, the cup having an inner wall and an upper rim, and a displacement head that inserts into the cup. The displacement head has an outer wall with a second circumference, where a difference between the first circumference and the second circumference is a constant circumferential gap that provides a region to form a frozen shell of a beverage along the inner wall of the cup.

A multi serve device is provided for making iced beverages. The device includes a frame, a set of cups arrange in an array in a holding tray, each of one of the set of cups having a first circumference, and further including an inner wall and an upper rim. A set of displacement heads is positioned above the set of cups that insert into the set of cups, each of the displacement heads having an outer wall with a second circumference, where a difference between the first circumference and the second circumference is a constant circumferential gap that provides a region to form a frozen shell of a beverage along the inner wall of the cup when the set of displacements heads is inserted in the set of cups. The multi serve device further includes a set of rows of cantilevered toggling lifter arms supported on the frame, an individual row from the set of rows each connected to a subset of the set of displacement heads that provide both a horizontal and vertical motion to the displacement heads to insert and retract the set of displacement heads from the set of cups, and a motor drive with a control arm mounted to the frame that actuates the set of rows of cantilevered toggling lifter arms.

A multi serve device is provided for making iced beverages. The device includes a frame, a set of cups arrange in an array in a holding tray, each of one of the set of cups having a first circumference, and further including an inner wall and an upper rim. The device further includes a movable platform that travels upwards and downwards in a vertical direction with respect to and above the set of cups along a set of rails attached to the frame; a set of displacement heads removably attached to a bottom portion of the movable platform, the set of displacement heads positioned above the set of cups and that insert into and retract from the set of cups, each of the displacement heads having an outer wall with a second circumference, where a difference between the first circumference and the second circumference is a constant circumferential gap that provides a region to form a frozen shell of a beverage along the inner wall of the cup when the set of displacements heads is inserted in the set of cups; and a motor drive with a control arm mounted to the frame that actuates the platform.

Methods of using the single serve and multi serve devices are also provided.

### BRIEF DESCRIPTION OF THE DRAWINGS

The present invention is further detailed with respect to the following drawings that are intended to show certain aspects of the present invention but should not be construed as a limit on the practice of the present invention.

FIGS. 1A-1F are a series of perspective views of the components that provide a single serve home unit cup for producing a frozen inner shell of a beverage along the inner wall of the cup in accordance with embodiments of the invention;

FIG. 2A is a perspective view of a displacement head with finger grooves on the lid portion of the displacement head in accordance with embodiments of the invention;

FIG. 2B is a perspective view of the displacement head of FIG. 2A inserted into an associated cup in accordance with embodiments of the invention;

FIG. 2C is cut away side view of the displacement head of FIG. 2A;

FIGS. 3A-3C are a series of partial perspective views of differing bottom portions of cups with protruding features and patterns that act to prevent frozen liquid from twisting when removing the inserted displacement head following formation of the perimeter ice shell in a cup in accordance with embodiments of the invention;

FIG. 4A is an exploded view of an additional embodiment of the components that provide a single serve home unit cup for producing a frozen inner shell of a beverage along the inner wall of the cup in accordance with embodiments of the invention;

FIG. 4B is a detailed view of the head ring shown in FIG. 2A;

FIGS. 5A-5F are a series of perspective views of a multi serve device that produces multiple prepared cups with a frozen inner shell of a beverage along the inner wall of the cups in accordance with embodiments of the invention; and

FIGS. 6A-6H are a series of perspective views of an additional embodiment of a multi serve device that produces multiple prepared cups with a frozen inner shell of a beverage along the inner wall of the cups in accordance with embodiments of the invention.

### DESCRIPTION OF THE INVENTION

The following description of the inventive embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless indicated otherwise, explicitly or by context, the following terms are used herein as set forth below. As used in the description of the invention and the appended claims, the singular forms “a,” “an” and “the” are intended to include the plural forms as well, unless the context clearly indicates otherwise. Also as used herein, “and/or” refers to and encompasses any and all possible combinations of one or more of the associated listed items, as well as the lack of combinations when interpreted in the alternative (“or”).

The invention has utility as a new device and method of making iced beverages. Embodiments of the iced beverage device and method can be made either as a commercial multi serve unit for restaurants, coffee shops, and convenience stores, or as a single serve for home use. Embodiments of the invention create a frozen inner shell that lines the inner perimeter of a serving cup of any beverage product, iced cream, smoothie, alcoholic beverage or mixer, dairy product, coffee, soft drink, juice, or any product which is required to be kept cold, by totally eliminating dilution and the need for ice. Therefore, for example instead of using ice to make iced coffee were the ice melts and dilutes the coffee, embodiments of the invention allow a person to pour coffee into a cup with an insert that forms an inner shell in the cup of the poured coffee that is then frozen and after the coffee has frozen about the inner perimeter of the cup, the insert is removed, and hot coffee can be poured into the cup to make iced coffee. This can be done for numerous beverages. So, when the perimeter coffee that was frozen melts, the drink does not get diluted by water, but with unfrozen coffee with a similar consistency with the poured in beverage.

Embodiments of the single serve home unit cup are designed to a make a frozen inner beverage shell in any home freezer utilizing a silicone displacement head which has the option to be filled either through an engineered lid top hole locked in place on the cup (which has a built-in ½ inch ridge around inner top of the cup to hold the shell in during head removal as well as when drinking a beverage without a straw), or the cup may also be prefilled with beverage, and a displacement head can be put in place afterwards creating the same effect by displacing liquid ready to freeze. After the liquid is poured in, the home unit cup is placed in a freezer for a long enough period to allow the liquid to freeze about the inner perimeter of the cup. After the liquid has frozen, a person takes the home unit cup out of the freezer and removes the silicone displacement head. The removal of the silicone displacement head is accomplished by simply pulling the head from the cup leaving a frozen perimeter shell intact inside the home unit cup. However, if the home unit cup is left in the freezer for extended period and over freezes, hot water can be poured into the center of the displacement head to precipitate seamless removal of the silicone displacement head.

Following the removal of the silicone displacement head, the person then pours liquid to fill the cup and the person now has a beverage that is kept cold by the frozen shell of the same beverage type. In other words, the person could freeze coffee and then after the coffee frozen shell is established and the displacement head is removed, the person then pours coffee into the home unit cup and now has iced coffee ready to drink. The advantage of this device is that instead of using ice to make iced coffee and having the ice melt which waters down the drink, by freezing the coffee first to create the outer shell, the frozen coffee shell will make the new coffee poured in cold and when the shell melts, the coffee is not being watered down. The result is a better tasting iced coffee drink. This concept can be used for just about any beverage and ice cream as well. For example, iced tea, beer, soda, hard liquor, etc. can be poured in first to create the frozen shell and then the same beverage can be poured in to create the iced beverage.

Embodiments of the inventive multi serve iced beverage device eliminates labor and machinery typically used to make traditional ice for both iced and cold beverages, improves efficiency and lowers costs in producing cooled beverages, while preventing dilution, preserving or improving product quality, eliminating waste, and sustaining temperature of product for extended periods. Embodiments of the invention provide the consumer with one hundred percent of actual product versus watered down ice by virtue of the frozen insulated barrier along the inside perimeter of the beverage container consisting of actual product ensuring optimum temperature, quality, and value for all cold beverages served. Additionally, inventive embodiments consistently measure portions and stabilize cost of goods by ensuring every unit is perfectly measured and uniform versus the user error commonly associated with ice in products. The unique frozen shell that lines the inner perimeter of a beverage cup made in embodiments of the invention provides a proprietary look and feel to a beverage that differentiates a commercial offering from others.

Embodiments of the inventive multi serve iced beverage device are configured for use with any original equipment manufacturer (OEM) freezer illustratively including a blast version, commercial upright, or walk in variety. Embodiments of the multi serve iced beverage device are configured around the industry standard “full sheet pan” so the invention can fit universally into a standard “bun rack” and/or upright freezer.

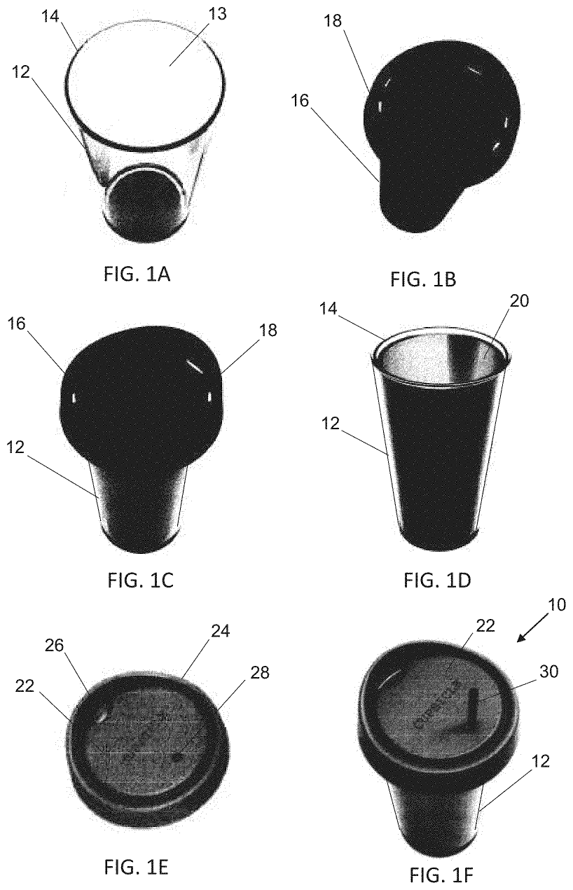

Referring now to the figures, FIGS. 1A-1F are a series of perspective views of the components that provide an embodiment of a single serve home unit 10 as shown fully assembled in FIG. 1F. As shown in FIG. 1A, a cup 12 for producing a frozen inner shell 20 of a beverage along the inner wall 13 of the cup 12 with an upper rim 14. The single serve cup 10 may be made of either glass, plastic, styro-foam, paper, acrylic, or silicone. The size of the cup 10 may vary between 236.5 ml (8 ounces) and 1.89 L (64 ounces). FIG. 1B is a perspective view a silicone displacement head 16 that is sized to be paired with a particular cup size of the cup 12. The displacement head 16 has a lip 18 that fits over the rim 14 of the cup 12 when the displacement head 16 is inserted into the cup 12. The displacement head 16 has an equivalent upward taper as that of the cup 12 that widens from bottom to top, that allows for a constant gap between the interior wall 13 of the cup 12 and the displacement head 16. FIG. 1C shows the displacement head 16 inserted in the cup 12. The constant gap provides the region where the frozen shell 20 as shown in FIG. 1D is formed when a liquid is either prefilled prior to inserting the displacement head 16 or added with the displacement head already inserted in the cup 12. FIG. 1D shows the cup coated along the inner wall 13 with a frozen inner shell 20 following placement of the assembly of FIG. 1C in a freezer. It is appreciated that the displacement head 16 may be sized with a corresponding cup 12 so as to form a frozen inner shell 20 that in specific inventive embodiments may have a thickness that may vary between one eighth and one inch along the interior wall 13 of the cup 12. FIG. 1E shows a cap 22 with a raised lip 24 that is fitted over rim 14 of the cup 12. The cap 22 has a drinking slot 26 and an aperture 28 for insertion of a straw 30. Following the removal of the displacement head 16, and the filling of the cup 12 with the frozen shell 20 of FIG. 1D with a liquid form of the beverage the cap 22 is fitted to the cup 12 as shown in FIG. 1F with a straw 30 inserted in the aperture 28.

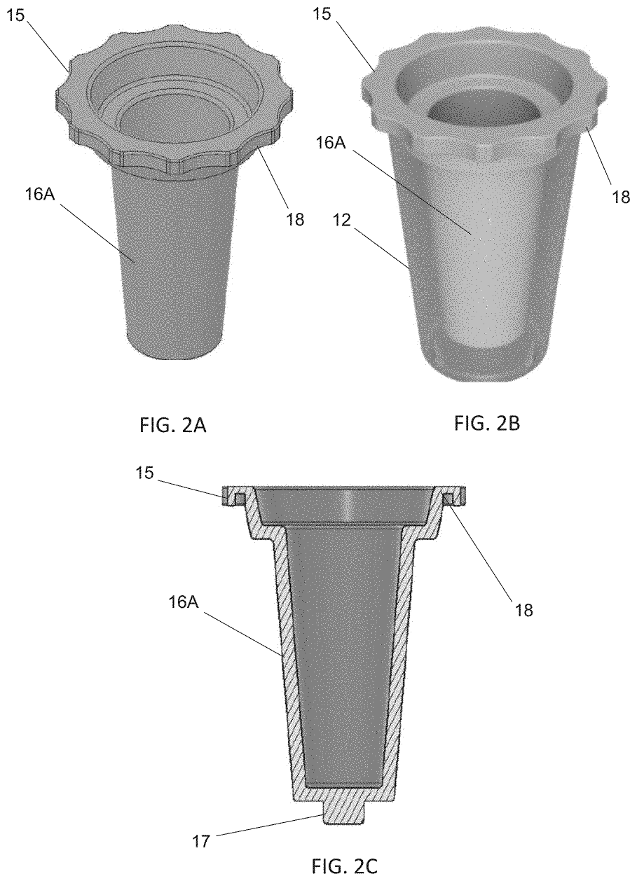

FIG. 2A is a perspective view of a displacement head 16A with finger grooves 15 on the lip portion 18 of the displacement head 16A. The finger grooves 15 or variations thereof allow a user to firmly grip the insert displacement head 16 during the removal process following the formation of the frozen inner shell 20 following placement of the assembly of FIG. 2B in a freezer. FIG. 2B is a perspective view of the displacement head 16A of FIG. 2A inserted into an associated cup 12. As noted above with respect to the embodiment shown if FIGS. 1A-1F, it is appreciated that the displacement head 16A may be sized with a corresponding cup 12 so as to form a frozen inner shell 20 that in specific inventive embodiments may have a thickness that may vary between one eighth and one inch along the interior wall 13 of the cup 12. FIG. 2C is cut away side view of the displacement head 16A of FIG. 2A. In specific embodiments a standoff 17 may be present at the bottom of the displacement head 16A to improve release from the cup 12.

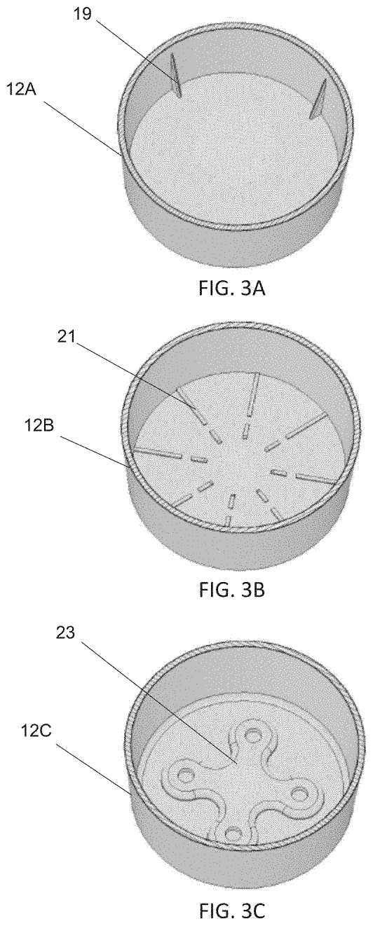

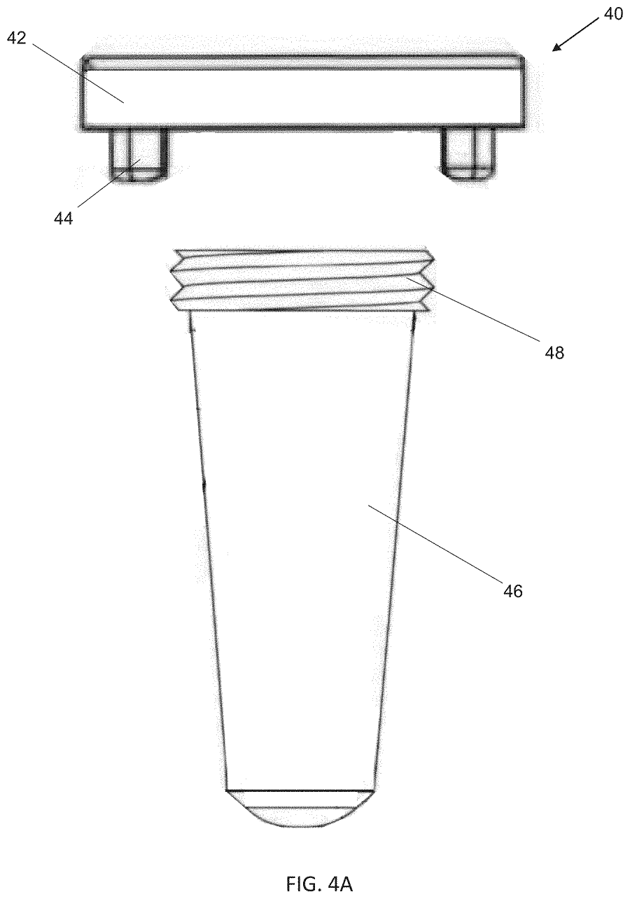

FIGS. 3A-3C are a series of partial perspective views of differing bottom portions of cups 12A-12C with flanges or fins 19, protruding features or ridges 21, and elevated patterns 23, respectively, that act to prevent frozen liquid from twisting when removing the inserted displacement head following formation of the perimeter ice shell 20 in a cup 12A.

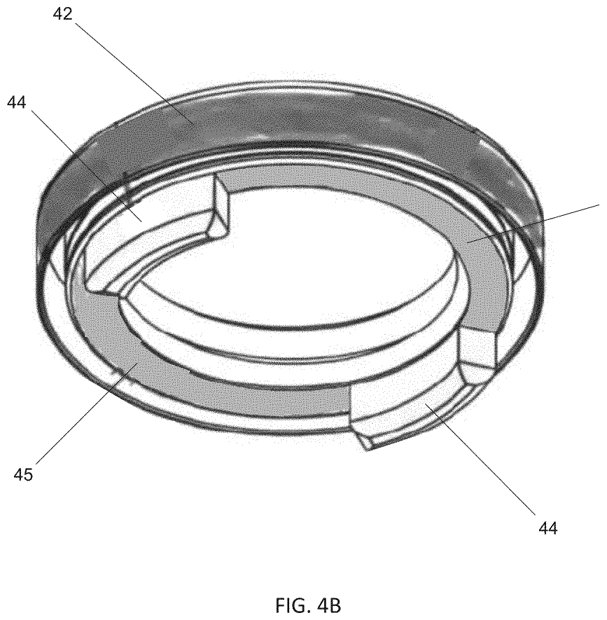

FIG. 4A is an exploded view of an additional embodiment 40 of the components that provide a single serve home unit cup for producing a frozen inner shell of a beverage along the inner wall of the cup. As noted above the size of the cup 10 may vary between 236.5 ml (8 ounces) and 1.89 L (64 ounces). The displacement head assembly 40 is sized to be paired with a particular cup size of the cup 12. The displacement head assembly 40 includes a displacement body 46 that may be threaded into the head ring 42 via complementary threads 48 at the top portion of the displacement body 46.

Once the head ring 42 and displacement body 46 are connected, the displacement head assembly 40 is submerged into the specified cup 12 based on the size of the cup. In other words, a sixteen ounce cup will have a corresponding head assembly 40 designated for sixteen ounce cups. The displacement head assembly 40 is secured to the outer edge of the rim of the cup 12 by the head ring 42 displacing the liquid or beverage to within ½ inch of the inner shell ring 45 that is shown in FIG. 4B. Following insertion of the displacement head body 46 into the cup 12, which has displaced the beverage around the outer perimeter of the displacement body 46, the cup 12 and the secured displacement head assembly 40 is then put into any home or commercial freezer for approximately 3 to 4 hours depending on inner freezer temperature. The frozen beverage will expand to put pressure on the inner shell ring 45 and slightly move the displacement head body 46 upward due to the expansion of the frozen liquid. After 3-4 hours the frozen cup 12 is removed from the freezer. A user simply holds the outer rim of the head ring 42, while gently turning the displacement head body 46 counterclockwise, which will then release the displacement head body 46 from the frozen shell of liquid utilizing a small amount of torque created by the threaded head ring 42 (just like a typical nut and bolt system). The head ring 42 can be easily removed from the cup (while still connected to the displacement head body 46) leaving a frozen inner shell of the liquid product within the cup. The head ring 42 has two opposing curved protrusions 44, which prevent the frozen inner shell from moving when the displacement head body 46 is being turned counterclockwise to separate the displacement head assembly 40 from the frozen shell in a finished cup. It is appreciated that the displacement head body 46 may be sized with a corresponding cup 12 so as to form a frozen inner shell 20 that in specific inventive embodiments may have a thickness that may vary between one eighth and one inch along the interior wall 13 of the cup 12. Frozen inner shells can be stored up to 45 days or more in the freezer if necessary and are ready to fill on demand Not to be limited to a particular theory, the displacement head assembly 40 provides a “Frozen Inner Shell Technology” by virtue of three disciplines: displacement, expansion, and torque.

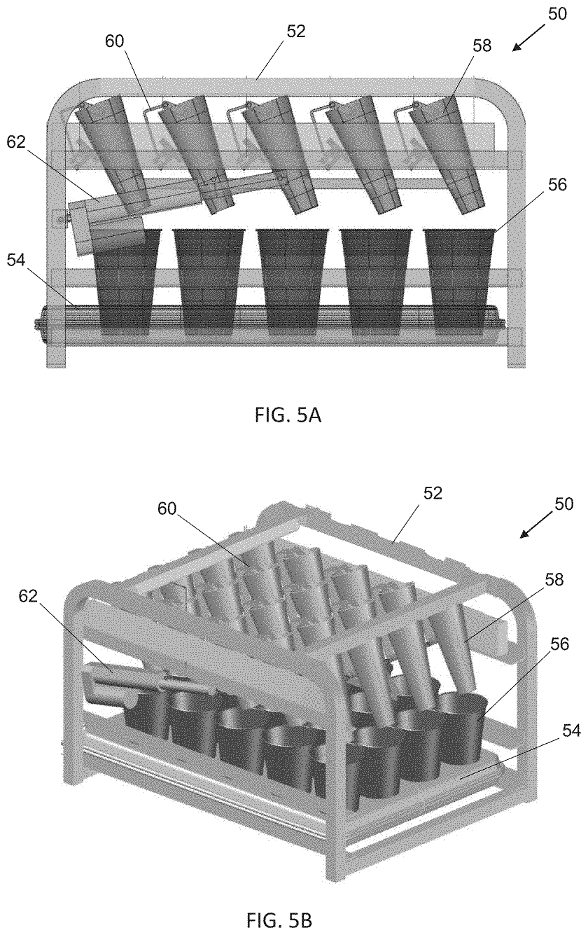

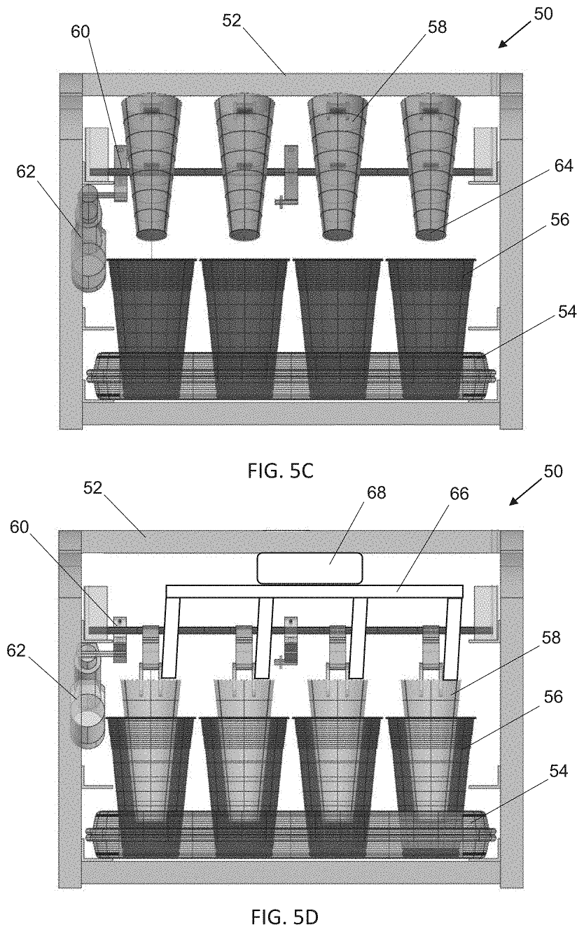

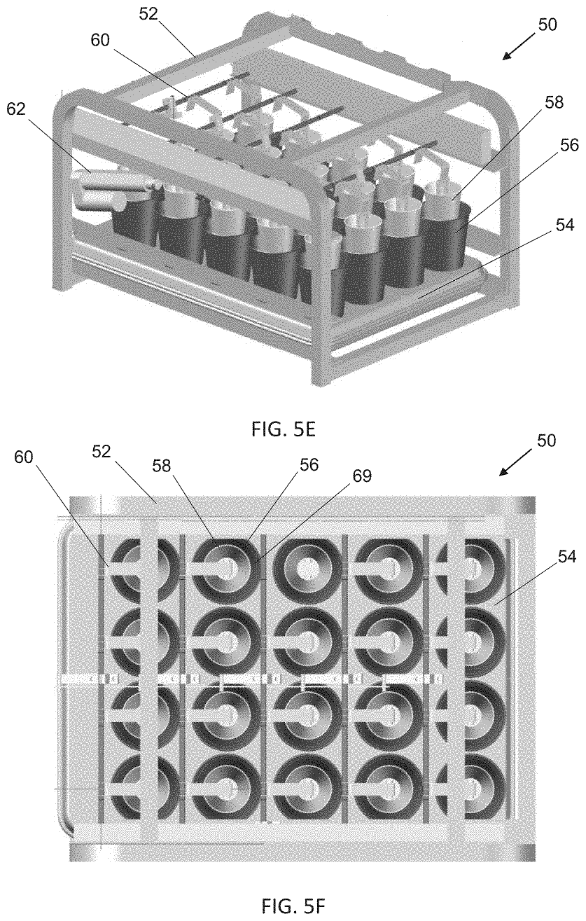

FIGS. 5A-5F are a series of perspective views of an embodiment of a multi serve device 50 that simultaneously produces multiple prepared cups 56 with a frozen inner shell of a beverage along the inner wall of the cups 56. FIGS. 5A and 5B are a side view and perspective view, respectively, of the multi serve device 50 formed in a frame 52, with the displacement heads 58 retracted from the cups 56. The cups 56 are arranged in an array in a holding tray 54. In the embodiment shown a four by five (4×5) array of cups 56 is held in the holding tray 54. It is appreciated that other configurations and numbers of cups are within the scope of the invention. The cups 56 may be made of glass, plastic, styro-foam, paper, acrylic, or silicone, and range in size from between 236.5 ml (8 ounces) and 1.89 L (64 ounces). The holding tray 54 may have a series of insertion apertures each lined with a gromet or rubber gasket to hold a base portion of each cup 56. A series of displacement heads 58 each having an equivalent upward taper as that of the cup 56 that widens from bottom to top, that allows for a constant gap between the interior wall of the cup 56 and the displacement head 58 when the displacement head 58 is inserted in the cup 56. The displacement heads 58 may be formed of stainless steel with a heating element built in to aid in release of the head following the freezing cycle. FIG. 5C is a front view multi serve device 50 with the displacement heads 58 retracted from the cups 56. The individual displacement heads 58 are each connected to cantilevered toggling lifter arms 60 that are actuated by a motor drive 62. The toggling lifter arms 60 provide both a horizontal and vertical motion to the displacement heads 58. The motor drive 62 may be a worm gear drive or a linear actuator. As shown in FIGS. 5D and 5E when the motor drive 62 retracts the displacement heads 58 are lowered into the cups 56, and conversely when the control arm of motor drive 62 extends the displacement heads 58 lift out and away from the cups 56. As seen in the top view of FIG. 5F, a constant gap 69 between the interior wall of the cup 56 and the displacement head 58 when the displacement head 58 is inserted in the cup 56 provides the region where the frozen shell 20 as shown in FIG. 1D is formed when a liquid is either prefilled prior to inserting the displacement head 58 or added with the displacement head already inserted in the cup 56. In a specific inventive embodiment, once displacement heads 58 are positioned in cups 56 properly, an auto fill cycle begins via an orifice 64 (shown in FIG. 5C) on bottom of the displacement heads 58 which is fed by food grade tubing 66 (shown in FIG. 5D) and being pushed by a pump 68 with the desired product.

In a particular implementation of the multi serve device 50 a method of operation is as follows. Empty cups 56 are loaded into the holding tray 54. Once cups 54 are firmly in place on each holding tray 54, the trays 54 are slid into one of seven shelves on a custom-made rolling rack which is designed with the equivalent measurements of any OEM bun or rolling rack. As the embodiment shown in FIGS. 5A-5F has twenty cups loaded per holding tray each shelf can accommodate twenty cups for a total of one hundred and forty cups per OEM bun or rolling rack. The holding trays 54 are then positioned in the multi serve device 50. The displacement heads 58 are then lowered into the cups 56. With the displacement heads 58 positioned in cups 56, an auto fill cycle begins via the orifice 64 on bottom of displacement heads 58 which is fed by food grade tubing 66 and is pushed by the pump 68 for the desired product. With the constant gap 69 areas of the cups 56 now filled, a freezer containing the racks with the cups 56 with filled perimeters begins cycling down between −34.4° C. (−30° F.) and −17.8° C. (0° F.) depending on frozen shell 20 specifications and the beverage called for by an end user. After a freeze cycle of between 18 and 36 minutes depending upon product and prescribed hardness of shell, the shell is fully formed, and the extraction cycle begins by slightly heating the stainless-steel displacement head 58 above 40.6° C. (105° F.) to insure seamless removal from cup. Displacement heads 58 are then automatically removed by reversing the exterior motor which turn the vertical and horizontal displacement rods to lift and remove displacement head from cup leaving frozen shell of product. Cups 56 with frozen inner shells 20 are then manually removed from the holding trays 54 where the cups 56 can be nested or stacked into either a storage or expediting freezer for a grab and go or ready to fill options. It is appreciated that specific inventive embodiments may have frozen inner shells 20 with a thickness that may vary between one eighth and one inch along the interior wall of the cup 56.

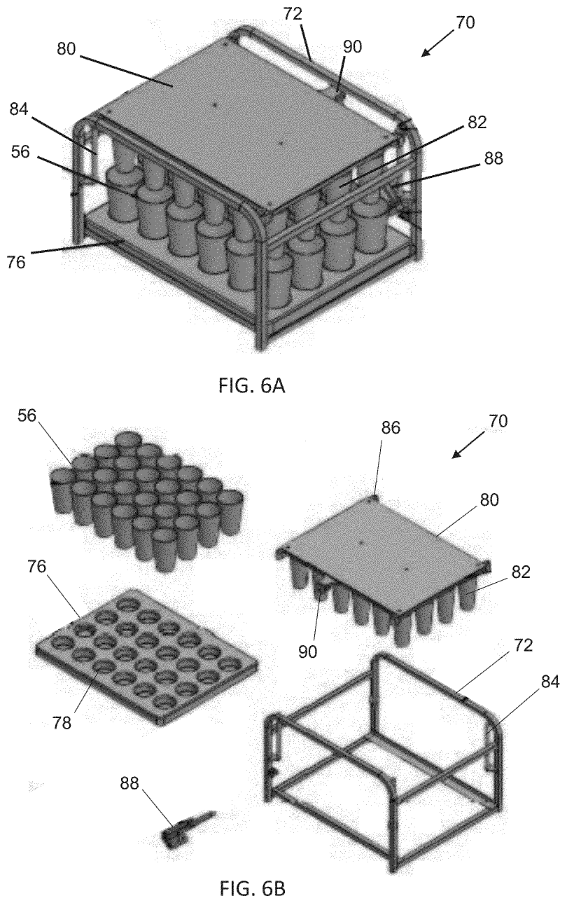

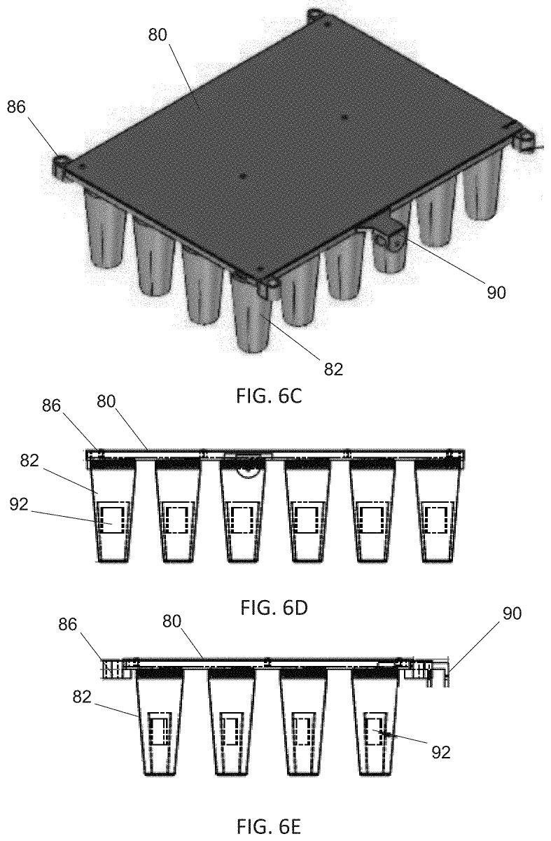

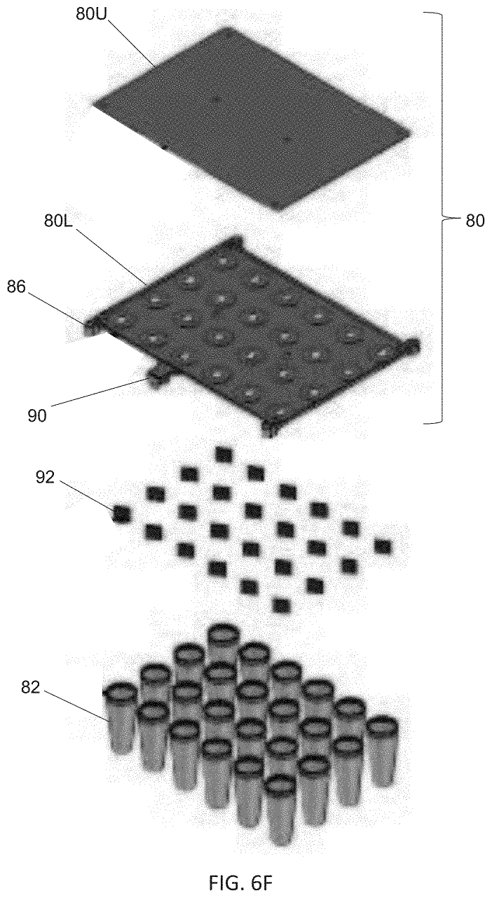

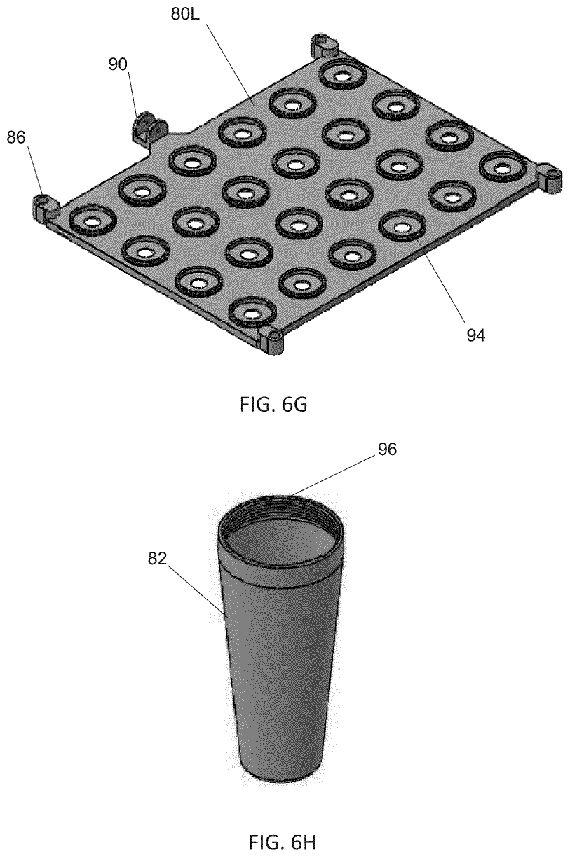

FIGS. 6A-6H are a series of perspective views of an additional embodiment of a multi serve device 70 that produces multiple prepared cups 56 with a frozen inner shell 20 of a beverage along the inner wall 13 of the cups 56. FIG. 6A is a perspective view of the multi serve device 70 formed in a frame 72, with the displacement heads 82 retracted from the cups 56. The cups 56 are arranged in an array in a holding tray 76. In the embodiment shown a four by six (4×6) array of cups 56 is held in the holding tray 76 as best shown in exploded view 6B. It is appreciated that other configurations and numbers of cups are within the scope of the invention. The cups 56 may be made of glass, plastic, styro-foam, paper, acrylic, or silicone, and range in size from between 236.5 ml (8 ounces) and 1.89 L (64 ounces). The holding tray 76 may have a series of insertion apertures 78 each lined with a gromet or rubber gasket to hold a base portion of each cup 56. A series of displacement heads 82 each having an equivalent upward taper as that of the cup 56 that widens from bottom to top, that allows for a constant gap between the interior wall of the cup 56 and the displacement head 82 when the displacement head 82 is inserted in the cup 56. The displacement heads 82 may be formed of stainless steel with a heating element 92 (see FIGS. 6D and 6E) built in to aid in release of the head following the freezing cycle. The displacement heads 82 are secured to the bottom portion 80L (see FIG. 6F) of a platform 80. As shown in FIG. 6F the platform 80 has an upper portion 80U and a bottom portion 80L. FIG. 6G shows the bottom portion 80L rotated by 180 degrees to show the threads 94 that provide securement to the corresponding threads 96 positioned on the inner lip of the displacement heads 82 as shown in FIG. 6H. The displacement heads 82 screw into the bottom portion 80L that allows for a change in size of the displacement heads 82 to adjust for a different size cups 56. It is appreciated that the displacement head 82 may be sized with a corresponding cup 56 so as to form a frozen inner shell 20 that in specific inventive embodiments may have a thickness that may vary between one eighth and one inch along the interior wall 13 of the cup 56.

A motor drive 88 moves the platform 80 upward and downward in the vertical direction with respect to the cups 56 on a set of rails 84 attached to the frame 72 using guides 86 that extend from the platform 80 along the rails 84. The movement of the platform 80 and the resultant vertical motion to the displacement heads 58 is in response to the actuation by the motor drive 88. The motor drive 88 may be a worm gear drive or a linear actuator. The motor drive 88 is attached to the platform at pivot point 90 as best shown in FIG. 6C.

Various modifications of the present invention, in addition to those shown and described herein, will be apparent to those skilled in the art of the above description. Such modifications are also intended to fall within the scope of the appended claims.

The foregoing description is illustrative of particular embodiments of the invention, but is not meant to be a limitation upon the practice thereof. The following claims, including all equivalents thereof, are intended to define the scope of the invention.

1. A single serve device for making iced beverages, the device comprising:
a cup with a first circumference, the cup comprising an inner wall and an upper rim; and
a displacement head that inserts into said cup, said displacement head comprising an outer wall with a second circumference, where a difference between the first circumference and the second circumference is a constant circumferential gap that provides a region to form a frozen shell of a beverage along the inner wall of said cup.

2. The device of claim 1 wherein said displacement head further comprises a lip that fits over and engages the upper rim of said cup.

3. The device of claim 1 wherein said displacement head is made of silicone.

4. The device of claim 1 wherein said cup is made of one of glass, plastic, styro-foam, paper, acrylic, or silicone.

5. The device of claim 1 wherein said cup has a size that is between 236.5 ml (8 ounces) and 1.89 L (64 ounces).

6. The device of claim 1 wherein said cup and said displacement head both have an upward taper that widens from bottom to top that maintains the constant circumferential gap.

7. The device of claim 1 further comprising a cap with a raised lip that is fitted over the upper rim of said cup when said displacement head is removed; and
wherein said cap has a drinking slot and an aperture for insertion of a straw.

8. A multi serve device for making iced beverages, the device comprising:
a frame;
a set of cups arrange in an array in a holding tray, each of one of said set of cups having a first circumference, and further comprising an inner wall and an upper rim;
a set of displacement heads positioned above said set of cups that insert into said set of cups, each of said displacement heads comprising an outer wall with a second circumference, where a difference between the first circumference and the second circumference is a constant circumferential gap that provides a region to form a frozen shell of a beverage along the inner wall of said cup when said set of displacements heads is inserted in said set of cups;
a set of rows of cantilevered toggling lifter arms supported on said frame, an individual row from the set of rows each connected to a subset of the set of displacement heads that provide both a horizontal and vertical motion to the displacement heads to insert and retract the set of displacement heads from said set of cups; and
a motor drive with a control arm mounted to said frame that actuates the set of rows of cantilevered toggling lifter arms.

9. The multi serve device of claim 8 wherein said displacement heads are formed of stainless steel.

10. The multi serve device of claim 9 wherein said displacement heads further comprise a heating element built in to aid in release of said set of displacement heads from said set of cups following a freezing cycle.

11. The multi serve device of claim 8 wherein said motor drive is worm gear drive or a linear actuator.

12. The multi serve device of claim 8 further comprising food grade tubing and a pump to supply a liquid to said set of cups.

13. The multi serve device of claim 8 wherein said set of cups are made of one of glass, plastic, styro-foam, paper, acrylic, or silicone, and range in size from between 236.5 ml (8 ounces) and 1.89 L (64 ounces).

14. The multi serve device of claim 8 wherein each of said cups and each of said displacement heads both have an upward taper that widens from bottom to top that maintains the constant circumferential gap.

15. A method of using the multi serve device of claim 8, the method comprising:
loading said set of cups into said holding tray;
positioning said holding tray in the multi serve device;
lowering said set of displacement heads into said set of cups;
filling said set of cups with a liquid to fill the constant circumferential gap in each cup of said set of cups;
placing said multi serve device with the filled set of cups into a freezer to form a frozen inner shell around the inner walls of each of said cups; and
removing said set of displacement heads from said set of cups.

16. A multi serve device for making iced beverages, the device comprising:
a frame;
a set of cups arrange in an array in a holding tray, each of one of said set of cups having a first circumference, and further comprising an inner wall and an upper rim;
a movable platform that travels upwards and downwards in a vertical direction with respect to and above said set of cups along a set of rails attached to said frame;
a set of displacement heads removably attached to a bottom portion of said movable platform, said set of displacement heads positioned above said set of cups and that insert into and retract from said set of cups, each of said displacement heads comprising an outer wall with a second circumference, where a difference between the first circumference and the second circumference is a constant circumferential gap that provides a region to form a frozen shell of a beverage along the inner wall of said cup when said set of displacements heads is inserted in said set of cups; and
a motor drive with a control arm mounted to said frame that actuates said platform.

17. The multi serve device of claim 16 wherein the bottom portion of said movable platform further comprises a plurality of sets of threads that provide securement to a corresponding set of threads on an inner lip of each displacement head of said set of displacement heads.

18. The multi serve device of claim 16 wherein said motor drive is worm gear drive or a linear actuator.

19. The multi serve device of claim 16 wherein said set of cups are made of one of glass, plastic, styro-foam, paper, acrylic, or silicone, and range in size from between 236.5 ml (8 ounces) and 1.89 L (64 ounces).

20. The multi serve device of claim 16 wherein said set of displacement heads are formed of stainless steel; and
wherein said displacement heads further comprise a heating element built-in to aid in release of said set of displacement heads from said set of cups following a freezing cycle.
